(19) United States
(12) Patent Application Publication
(10) Pub. No.: US 2021/0295254 A1
(43) Pub. Date: Sep. 23, 2021

(54) DELIVERY PERSON EVALUATION SYSTEM

(71) Applicant: HONDA MOTOR CO., LTD., Tokyo (JP)

(72) Inventor: Ryo TAKEBAYASHI, WAKO-SHI (JP)

(21) Appl. No.: 16/821,224

(22) Filed: Mar. 17, 2020

(51) Int. Cl. G06Q 10/08; G06K 9/00; G07C 9/00

(52) U.S. Cl. CPC G06Q 10/0832; G06Q 10/0833; G07C 9/00309; G06K 9/00791; G06K 9/00832

(57) ABSTRACT

A delivery person evaluation system for evaluating a delivery person who delivers a parcel to a vehicle is equipped with an object detection unit that detects an amount of objects that have a possibility of being made to increase in the vehicle when the delivery person accommodates the parcel in the vehicle, and an evaluation unit that makes an evaluation of the delivery person on the basis of pre-delivery information indicative of the amount of objects detected by the object detection unit before the parcel is accommodated in the vehicle, and post-delivery information indicative of the amount of objects detected by the object detection unit after the parcel has been accommodated in the vehicle.

### BACKGROUND OF THE INVENTION

### Field of the Invention

The present invention relates to a delivery person evaluation system by which a delivery person who delivers a parcel to a vehicle is evaluated.

### Description of the Related Art

In Japanese Laid-Open Patent Publication No. 2006-206225, a technique is disclosed in which the vehicle of a recipient is used as a reception location, in order to deliver a parcel even in the case that the recipient of the parcel is absent. In accordance with such a technique, the trunk of the vehicle is unlocked by performing mutual authentication between a communication device of a delivery person and the vehicle for receiving the parcel. According to the technique disclosed in Japanese Laid-Open Patent Publication No. 2006-206225, the delivery person can deliver the parcel to the vehicle regardless of the presence or absence of the recipient.

### SUMMARY OF THE INVENTION

In the technique disclosed in Japanese Laid-Open Patent Publication No. 2006-206225, when a delivery person delivers the parcel to the vehicle, the recipient is not present in the vehicle. For this reason, there is a possibility that the delivery person may fail to exercise caution in relation to care and treatment of the vehicle. For example, in the case that litter or waste enters into the vehicle, the recipient will experience a sense of discomfort. If such mishandling happens frequently, the reputation of the delivery company will be lowered. In order to avoid a decline in the reputation of the delivery company, the delivery company needs to evaluate the delivery person and provide appropriate guidance.

The present invention has been devised taking into consideration the aforementioned problems, and has the object of providing a delivery person evaluation system that enables a delivery person to be evaluated.

An aspect of the present invention is characterized by a delivery person evaluation system configured to evaluate a delivery person who delivers a parcel to a vehicle, the delivery person evaluation system comprising an object detection unit configured to detect an amount of objects that have a possibility of being made to increase in the vehicle when the delivery person accommodates the parcel in the vehicle, and an evaluation unit configured to evaluate the delivery person on the basis of pre-delivery information indicative of the amount of objects detected by the object detection unit before the parcel is accommodated in the vehicle, and post-delivery information indicative of the amount of objects detected by the object detection unit after the parcel has been accommodated in the vehicle.

According to the present invention, the delivery person can be evaluated.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a diagram showing the configuration of a delivery person evaluation system according to a first embodiment;

FIG. 2 is a functional block diagram showing the configuration of a delivery server;

FIG. 3 is a functional block diagram showing the configuration of a vehicle according to the first embodiment;

FIG. 4 is a sequence diagram showing a pre-delivery process;

FIG. 5 is a diagram showing the flow of a receiving process performed by the vehicle according to the first embodiment;

FIG. 6 is a diagram showing the flow of an evaluation process performed by the delivery server;

FIG. 7 is a diagram showing the configuration of a delivery person evaluation system according to a second embodiment;

FIG. 8 is a block diagram showing the configuration of a camera unit and a vehicle according to the second embodiment;

FIG. 9 is a diagram showing the flow of a receiving process performed by the vehicle according to the second embodiment;

FIG. 10 is a diagram showing a flow of an image capturing process performed by the camera unit according to the second embodiment; and

FIG. 11 is a diagram showing a lighting control unit provided in a vehicle according to another embodiment.

### DESCRIPTION OF THE PREFERRED EMBODIMENTS

Preferred embodiments of a delivery person evaluation system according to the present invention will be presented and described in detail below with reference to the accompanying drawings.

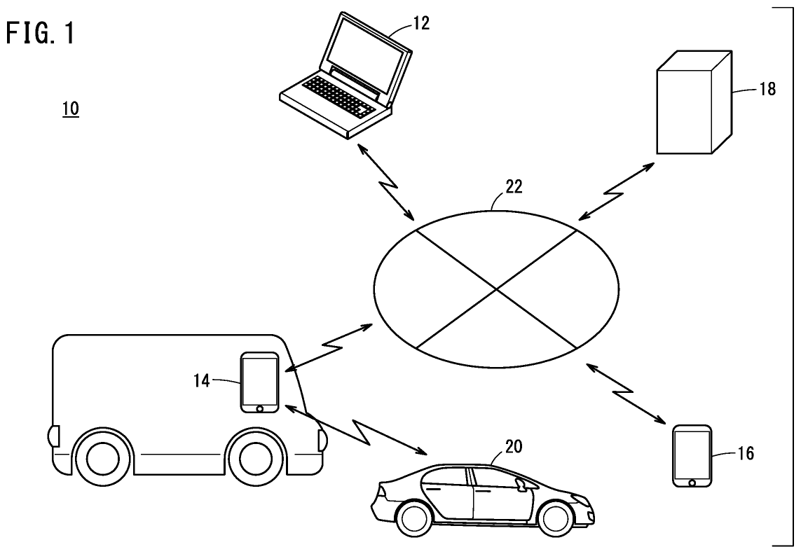

The delivery person evaluation system 10 according to the present invention is used for a vehicle delivery service provided by a courier (delivery company). The vehicle delivery service is a service in which a delivery person delivers a parcel to a vehicle 20, in the case that a recipient of the parcel specifies the vehicle 20 (see FIG. 1, etc.) as a delivery location for the parcel. The recipient designates a trunk or a cabin of the vehicle 20 as a space (accommodation space) in which the parcel is to be accommodated. The delivery person accommodates the parcel in the accommodation space that was designated by the recipient.

### 1. First Embodiment

In the vehicle delivery service, when the delivery person accommodates the parcel in the accommodation space, there is a concern that insects and litter or waste may enter into the accommodation space. Recipients dislike it when foreign substances (insects or litter, etc.) enter into the accommodation space. Therefore, in order to improve the quality of the service, the delivery company provides instructions to the delivery person to prevent foreign substances from entering into the accommodation space. Furthermore, the delivery company uses the amount of foreign substances that enter into the accommodation space as a criterion for evaluating the delivery person. According to the first embodiment, an evaluation of this type is performed.

### 1.1. Configuration of Delivery Person Evaluation System 10

As shown in FIG. 1, the delivery person evaluation system 10 according to the first embodiment is equipped with devices such as a provider terminal 12, a carrier terminal 14, a customer terminal 16, a delivery server 18, a vehicle 20, and the like. The respective devices are capable of mutually transmitting and receiving information via an information communication network 22 such as the Internet.

### 1.1.1. Provider Terminal 12, Carrier Terminal 14, Customer Terminal 16

The provider terminal 12 is a device installed in an office or the like of a delivery company, and is constituted, for example, by a personal computer. The carrier terminal 14 is a device that is carried by the delivery person, and is constituted, for example, by a smartphone, a tablet, a laptop personal computer, a dedicated terminal, or the like. The customer terminal 16 is a device that can be operated by a customer who is a recipient of the parcel, and is configured, for example, by a personal computer, a smartphone, a tablet, or a laptop personal computer.

### 1.1.2. Delivery Server 18

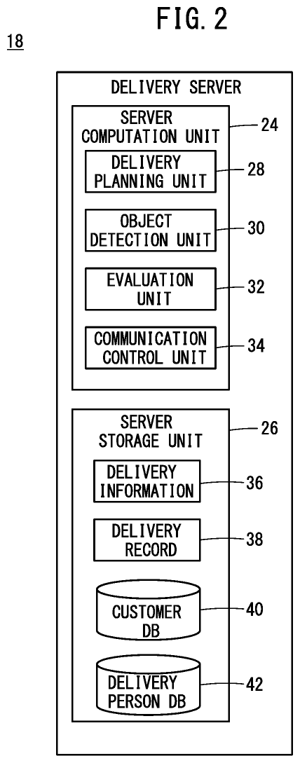

The delivery server 18 is a device that is used by the delivery company, and is constituted by a computer. As shown in FIG. 2, the delivery server 18 includes a server computation unit 24 including a processor, a server storage unit 26 having a RAM and a ROM, etc., a non-illustrated input/output device, a communications interface, and the like.

The server computation unit 24, by programs being executed by the processor, functions as a delivery planning unit 28, an object detection unit 30, an evaluation unit 32, and a communication control unit 34. The delivery planning unit 28 makes a delivery plan for delivery of the parcel. For example, the delivery planning unit 28 determines a delivery date and time and a delivery person for the parcel, on the basis of information transmitted from the provider terminal 12, information stored in a later-described delivery person database 42, and information transmitted from the customer terminal 16. On the basis of image information transmitted from the vehicle 20, the object detection unit 30 detects an amount of objects that have a possibility of being made to increase in the vehicle 20 when the delivery person accommodates the parcel in the vehicle 20. The object detection unit 30 detects the amount of objects before the parcel is accommodated in the vehicle 20 (referred to as pre-delivery information), and the amount of objects after the parcel has been accommodated in the vehicle 20 (referred to as post-delivery information). In the first embodiment, the objects detected by the object detection unit 30 are the above-described foreign substances (insects or litter, etc.). On the basis of the pre-delivery information and the post-delivery information, the evaluation unit 32 makes an evaluation of the delivery person. The communication control unit 34 transmits various information to each of the devices.

The server storage unit 26, in addition to various programs, stores delivery information 36 and a delivery record 38. The delivery information 36 is information created for each delivery, and is created at a stage that a delivery to the vehicle 20 is determined. The delivery information 36 includes the delivery date and time, the contents of the delivery, the name of the recipient (customer), information of the vehicle 20 (referred to as vehicle information) that serves as the delivery destination, and the like. The vehicle information includes information such as identifying information of the vehicle 20 (the vehicle type and number, etc.), a parking location of the vehicle 20, a designated accommodation space (a trunk or a cabin), and the like. On the other hand, the delivery record 38 is information created for each delivery operation, and is created after the delivery operation has been performed. The delivery record 38 includes image information acquired before and after the delivery, and information such as a delivery person number and the like.

Further, in the server storage unit 26, a customer database 40 (referred to as a customer DB 40) and a delivery person database 42 (referred to as a delivery person DB 42) are created. The customer DB 40 stores information of customers (referred to as customer information) who can receive the vehicle delivery service. The customer information includes information such as the address, the name, the contact address (such as a telephone number and an email address or the like), the vehicle information, and the like. On the other hand, the delivery person DB 42 stores information of delivery persons (referred to as delivery person information). The delivery person information includes information such as the name, the delivery person number, evaluations of the delivery person, a work schedule of the delivery person, and the like.

### 1.1.3. Vehicle 20

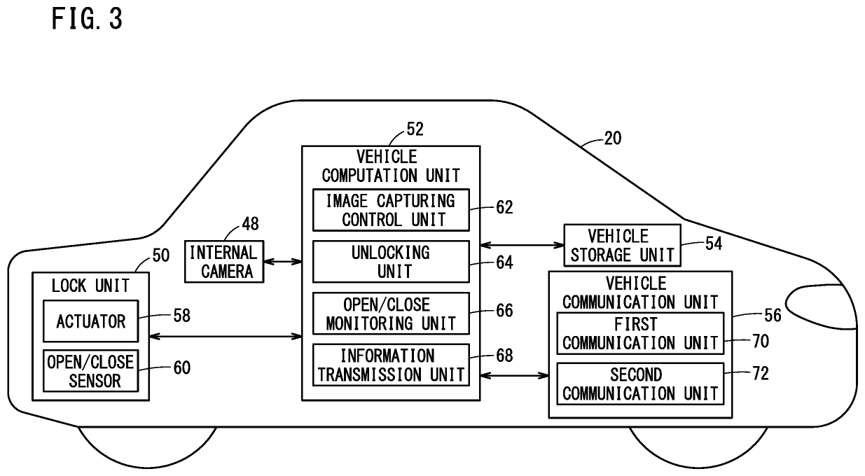

The vehicle 20 is parked in a specified location (a parking location for the vehicle 20 stored in the customer DB 40) at the delivery date and time. As shown in FIG. 3, the vehicle 20 is equipped with an internal camera 48, a lock unit 50, a vehicle computation unit 52, a vehicle storage unit 54, a vehicle communication unit 56, and the like.

The internal camera 48 is arranged at a position where an image can be captured of the accommodation space of the vehicle 20. The internal camera 48 may be an infrared camera that is capable of capturing images even in a state in which the accommodation space is dark, or may be a camera that operates in conjunction with lighting (not shown). In the first embodiment, the internal camera 48 captures a still image, however, a moving image may also be captured.

The lock unit 50 is a device that locks or unlocks a lock of a door that opens and closes the accommodation space. The lock unit 50 is equipped with an actuator 58 that switches between a locked state and an unlocked state of the lock, a drive circuit (not shown) that drives the actuator 58, an open/close sensor 60 that detects an opened or closed state of the door provided at the entrance to the accommodation space, and the like. In the case that the accommodation space is the cabin, the lock unit 50 switches between a locked state and an unlocked state of the door lock. In the case that the accommodation space is the trunk, the lock unit 50 switches between a locked state and an unlocked state of a lock for the trunk lid.

The vehicle computation unit 52 includes a processor. By the processor thereof executing programs, the vehicle computation unit 52 functions as an image capturing control unit 62, an unlocking unit 64, an open/close monitoring unit 66, and an information transmission unit 68. The image capturing control unit 62 controls an image capturing operation of the internal camera 48, and causes the vehicle storage unit 54 to temporarily store the image information acquired by the internal camera 48. The unlocking unit 64 unlocks the lock of the lock unit 50. The open/close monitoring unit 66 monitors the open or closed state of a door or an opening of the accommodation space based on the detection result of the open/close sensor 60. The information transmission unit 68 transmits various types of information to the exterior via the vehicle communication unit 56.

The vehicle storage unit 54 includes a RAM and a ROM or the like. In addition to various programs, the vehicle storage unit 54 stores a preset virtual key. The virtual key is defined by electronic information that is necessary in order to unlock the lock of the lock unit 50.

The vehicle communication unit 56 includes a first communication unit 70 for exchanging information with the carrier terminal 14, and a second communication unit 72 for exchanging information with respective devices via the information communication network 22. The first communication unit 70 utilizes a technique of short range wireless communications, such as infrared communications or Bluetooth (registered trademark). Each of the communication devices includes a communication circuit, an antenna, and the like.

### 1.2. Pre-Delivery Process

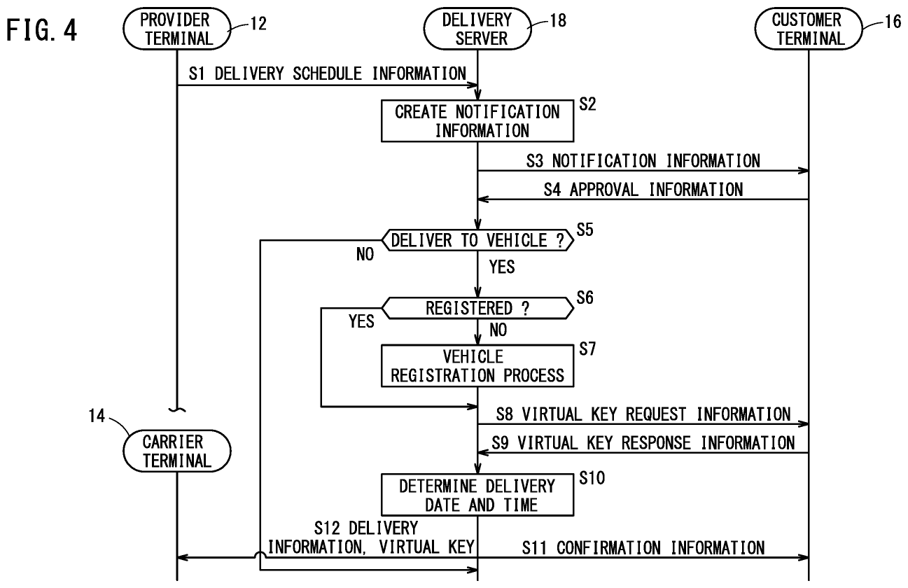

When the delivery request is generated, an operator of the delivery company operates the provider terminal 12 to thereby generate delivery schedule information. The delivery schedule information includes information such as the address of the recipient, the name of the recipient (customer), contact information (a telephone number, an email address, etc.) of the recipient, a scheduled delivery date and time, and the contents of the parcel. When the delivery schedule information is generated, the process proceeds according to the procedure shown in FIG. 4.

In step S1, the provider terminal 12 transmits the generated delivery schedule information to the delivery server 18.

In step S2, the delivery planning unit 28 of the delivery server 18 creates notification information on the basis of the delivery schedule information. The notification information includes, in addition to information such as the scheduled delivery date and time and the contents of the delivery and the like, an inquiry as to whether or not the delivery destination is the vehicle 20.

In step S3, the communication control unit 34 transmits the notification information to the customer terminal 16. The communication control unit 34 sets the email address of the recipient included in the delivery schedule information as a transmission destination of the notification information. Alternatively, the communication control unit 34 may search for the recipient information from within the customer DB 40, and may use an email address included within the searched information as the transmission destination of the notification information.

In step S4, the customer terminal 16 replies or transmits back approval information to the delivery server 18. The approval information is transmitted back in the case that the recipient approves of the scheduled delivery date and time. Moreover, although not illustrated, in the case that the recipient does not approve of the scheduled delivery date and time, the customer terminal 16 transmits back non-approval information to the delivery server 18. In this case, the processes of step S2 and step S3 are performed again. The delivery planning unit 28 proposes another delivery date and time. The approval information includes, in addition to the information indicating the intention of the approval, a response made with respect to the inquiry included in the notification information (whether or not the delivery destination is the vehicle 20).

In step S5, the delivery planning unit 28 determines whether or not to deliver the parcel to the vehicle 20 on the basis of the approval information. In the case of delivering to the vehicle 20 (step S5: YES), the process proceeds to step S6. On the other hand, in the case of not delivering to the vehicle 20 (step S5: NO), the pre-delivery process is brought to an end. In this case, the delivery person does not deliver the parcel to the vehicle 20, but delivers the parcel to the address of the recipient included in the delivery schedule information.

In step S6, the delivery planning unit 28 determines whether or not the vehicle information is registered in the information of the recipient that is stored in the customer DB 40. In the case of being registered (step S6: YES), the process proceeds to step S8. On the other hand, in the case of not being registered (step S6: NO), the process proceeds to step S7.

In step S7, a vehicle registration process is performed. Although not illustrated, the communication control unit 34 transmits guidance information to facilitate registration of the vehicle to the customer terminal 16. In the case that the customer terminal 16 replies with the vehicle information, the delivery planning unit 28 registers the vehicle information in the customer DB 40. Moreover, in the case that the customer terminal 16 does not reply with the vehicle information, the pre-delivery process is brought to an end. In this case, the delivery person does not deliver the parcel to the vehicle 20, but delivers the parcel to the address of the recipient included in the delivery schedule information.

In step S8, the communication control unit 34 transmits virtual key request information to the customer terminal 16. The virtual key request information is an inquiry concerning a virtual key made with respect to the customer terminal 16 from the delivery server 18.

In step S9, the customer terminal 16 transmits virtual key response information to the delivery server 18. The virtual key response information is information concerning the virtual key.

In step S10, the delivery planning unit 28 determines the scheduled delivery date and time approved by the recipient as the official delivery date and time. Furthermore, the communication control unit 34 creates the delivery information 36.

In step S11, the communication control unit 34 transmits confirmation information to the customer terminal 16. The confirmation information includes information such as the delivery date and time, the contents of the parcel, and the name of the delivery person and the like. The recipient verifies the confirmation information transmitted to the customer terminal 16, and parks the vehicle 20 in the registered parking location by the delivery date and time.

In step S12, the communication control unit 34 transmits the delivery information 36 and the virtual key to the carrier terminal 14. The delivery person verifies the delivery information 36 that was transmitted to the carrier terminal 14, and performs the delivery at the designated delivery date and time.

### 1.3. Receiving Process Performed by Vehicle 20

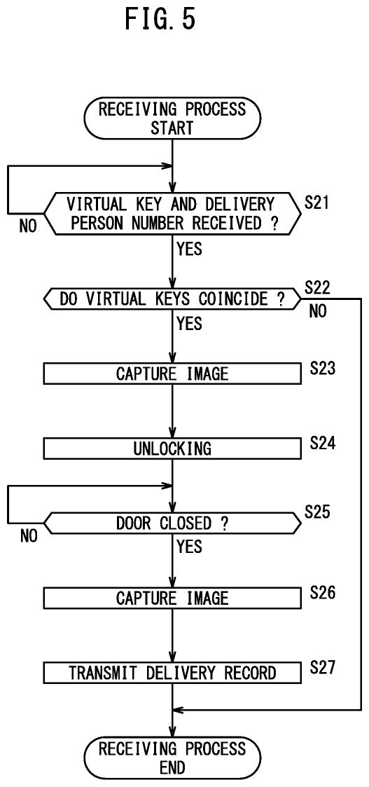

The receiving process shown in FIG. 5 is executed by the vehicle 20 while the vehicle 20 is parked. The receiving process is started in response to a trigger such as an operation of a process start switch (not shown), or an operation to turn off a power switch (not shown) of the vehicle 20, or the like.

When the delivery person arrives at the parking location of the vehicle 20, the carrier terminal 14 performs a pairing operation between the carrier terminal 14 and the vehicle communication unit 56. When the pairing operation is performed, the unlocking unit 64 is made capable of receiving the virtual key and the delivery person number from the carrier terminal 14. When the delivery person operates the carrier terminal 14 upon completion of the pairing operation, the carrier terminal 14 transmits the virtual key and the delivery person number.

In step S21, the unlocking unit 64 determines whether or not the virtual key and the delivery person number have been received. In the case that the unlocking unit 64 has received the virtual key and the delivery person number (step S21: YES), the process proceeds to step S22. On the other hand, in the case that the unlocking unit 64 has not received the virtual key and the delivery person number (step S21: NO), the process of step S21 is performed repeatedly.

In step S22, the unlocking unit 64 compares the received virtual key with the virtual key stored in the vehicle storage unit 54, and determines whether or not the two coincide with each other. In the case of coinciding (step S22: YES), the process proceeds to step S23. On the other hand, in the case of not coinciding (step S22: NO), the receiving process is brought to an end.

In step S23, the image capturing control unit 62 outputs an image capturing signal to the internal camera 48. The internal camera 48 captures an image of the accommodation space in accordance with the image capturing signal. The image capturing control unit 62 causes the vehicle storage unit 54 to temporarily store the image information acquired by the internal camera 48. In this instance, the stored image information (pre-delivery information) indicates the appearance of the accommodation space before the door is opened. After the process of step S23 has been executed, the process proceeds to step S24.

In step S24, the unlocking unit 64 transmits an unlocking signal to the lock unit 50. The drive circuit of the lock unit 50 energizes the actuator 58 in accordance with the unlocking signal. Upon doing so, the actuator 58 is driven and unlocked. Accompanying such unlocking, it becomes possible to open the door, and accommodation of the parcel is made possible. After the process of step S24 has been executed, the process proceeds to step S25.

In step S25, the open/close monitoring unit 66 monitors the open or closed state of the door on the basis of the detection result of the open/close sensor 60. In the case of the door being closed (step S25: YES), the process proceeds to step S26. On the other hand, in the case of the door not being closed (step S25: NO), the process of step S25 is performed repeatedly.

In step S26, the image capturing control unit 62 outputs the image capturing signal again to the internal camera 48. The internal camera 48 captures an image of the accommodation space in accordance with the image capturing signal. The image capturing control unit 62 causes the vehicle storage unit 54 to temporarily store the image information acquired by the internal camera 48. In this instance, the stored image information (post-delivery information) indicates the appearance of the accommodation space after the door has been closed. After the process of step S26 has been executed, the process proceeds to step S27.

In step S27, the information transmission unit 68 associates the pre-delivery information, the post-delivery information, and the delivery person number, and thereby generates the delivery record 38. The information transmission unit 68 transmits the delivery record 38 to the delivery server 18. The delivery server 18 stores the delivery record 38 transmitted from the vehicle 20 in the server storage unit 26. Upon completion of the foregoing steps, the receiving process is brought to an end.

### 1.4. Evaluation Process Performed by Delivery Server 18

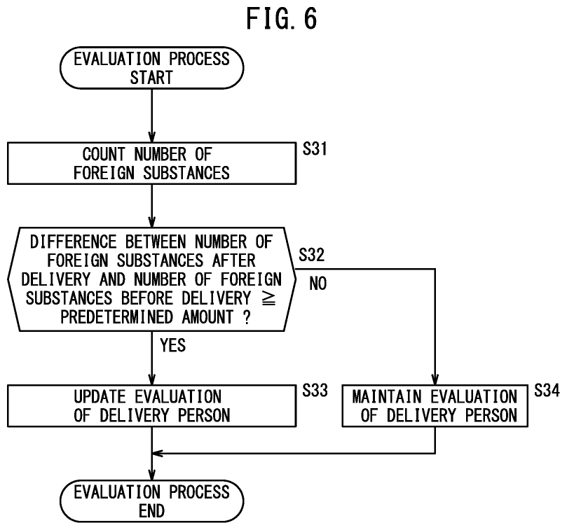

The evaluation process shown in FIG. 6 is executed by the delivery server 18. The evaluation process is performed periodically.

In step S31, the object detection unit 30 reads out the delivery record 38 stored in the server storage unit 26, and analyzes each of the images (the pre-delivery image and the post-delivery image). The object detection unit 30 performs image recognition, and detects predetermined foreign substances included in each of the images. Furthermore, the object detection unit 30 counts the number of foreign substances before and after the delivery. After the process of step S31 has been executed, the process proceeds to step S32.

In step S32, the evaluation unit 32 determines whether of not the difference between the number (amount) of foreign substances after delivery and the number (amount) of foreign substances before delivery is greater than or equal to a predetermined amount, or stated otherwise, whether the foreign substances before and after the delivery has increased to an amount that is greater than or equal to the predetermined amount. In the case that the difference is greater than or equal to the predetermined amount (step S32: YES), the process proceeds to step S33. On the other hand, in the case that the difference is less than the predetermined amount (step S32: NO), the process proceeds to step S34.

In step S33, the evaluation unit 32 uses the delivery person number included in the delivery record 38, and performs a search for corresponding delivery person information from within the delivery person information that is stored in the delivery person DB 42. In addition, the evaluation unit 32 updates the evaluation of the corresponding delivery person. For example, the evaluation unit 32 lowers the evaluation included within the delivery person information. The evaluation unit 32 may lower the evaluation by a predetermined rank, or may lower the evaluation by a rank corresponding to the difference calculated in step S32.

In step S34, the evaluation unit 32 maintains the evaluation of the delivery person without making changes thereto. Upon completion of step S33 or step S34, the evaluation process is brought to an end.

The delivery server 18 may also transmit the evaluation result to the carrier terminal 14. Furthermore, the delivery server 18 may collect evaluations from customers in relation to deliveries, and may transmit the results thereof and comments to the carrier terminal 14. In accordance with such a process, it leads to an improvement in the skills of the delivery person.

### 2. Second Embodiment

In the vehicle delivery service, when the delivery person accommodates the parcel in the accommodation space, there is a concern that scratches or uncleanliness (staining, etc.) may be applied to the surface of the vehicle 20. Recipients dislike it when scratches or uncleanliness is applied to the surface of the vehicle 20. Therefore, in order to improve the quality of the service, the delivery company provides instructions to the delivery person to prevent scratches and uncleanliness from being applied to the surface of the vehicle 20. Furthermore, the delivery company uses the amount of scratches or uncleanliness applied to the surface of the vehicle 20 as a criterion for evaluating the delivery person. According to the second embodiment, an evaluation of this type is performed.

The first embodiment and the second embodiment coincide with one another in many respects. Hereinafter, a description will be given of the portions of the second embodiment that differ from the first embodiment. In the second embodiment, constituent elements that are common with the first embodiment are denoted by the same reference numerals.

### 2.1. Configuration of Delivery Person Evaluation System 10

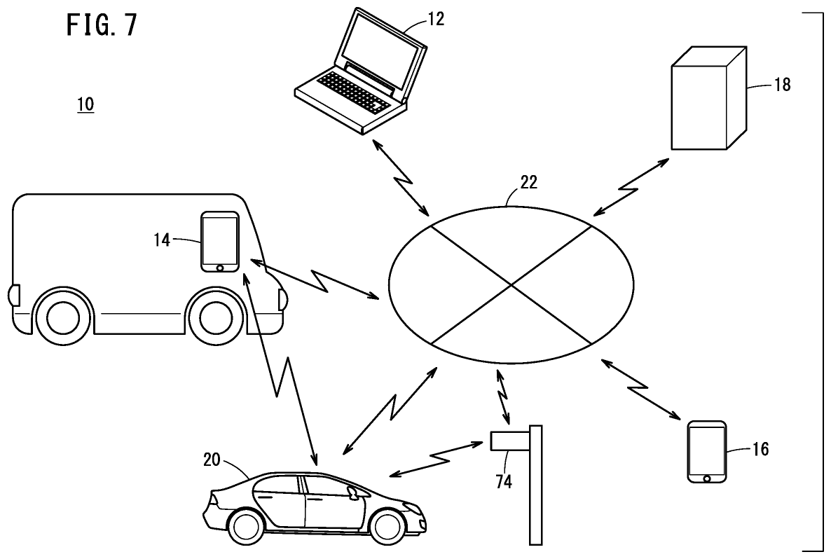

As shown in FIG. 7, the delivery person evaluation system 10 according to the second embodiment is equipped with devices such as the provider terminal 12, the customer terminal 16, the carrier terminal 14, the delivery server 18, the vehicle 20, a camera unit 74, and the like. The respective devices are capable of mutually transmitting and receiving information via the information communication network 22.

### 2.1.1. Delivery Server 18

The configuration of the delivery server 18 of the second embodiment is the same as the configuration of the delivery server 18 of the first embodiment. Moreover, in the second embodiment, the objects detected by the object detection unit 30 are scratches or uncleanliness on the surface of the vehicle 20.

### 2.1.2. Vehicle 20

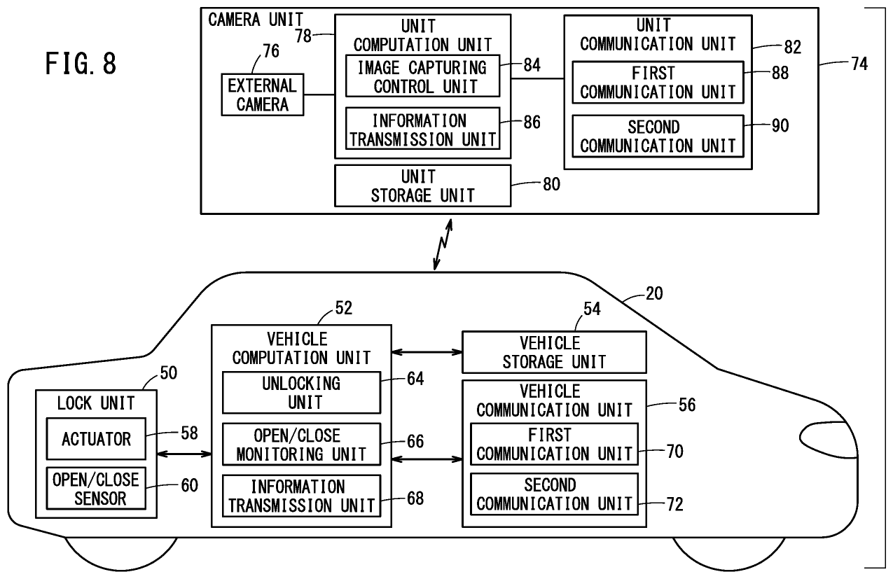

The vehicle 20 is parked in a specified location (a parking location stored in the customer DB 40) at the delivery date and time. As shown in FIG. 8, the configuration of the vehicle 20 of the second embodiment is the same as the configuration of the vehicle 20 of the first embodiment, except that the internal camera 48 and the image capturing control unit 62 of the first embodiment are not provided.

Moreover, in the second embodiment, the vehicle communication unit 56 (first communication unit 70) of the vehicle 20 and a unit communication unit 82 (first communication unit 88) of the camera unit 74 are capable of communicating with each other.

### 2.1.3. Camera Unit 74

The camera unit 74 is installed in the vicinity of the parking location for the vehicle 20. The camera unit 74 may be a monitoring camera device installed at a residence, a store, or a road, or may be a drive recorder provided in another vehicle. As shown in FIG. 8, the camera unit 74 is equipped with an external camera 76, a unit computation unit 78, a unit storage unit 80, the unit communication unit 82, and the like.

The external camera 76 is arranged at a position where an image can be captured of the door of the accommodation space of the vehicle 20. The external camera 76 may be an infrared camera that is capable of capturing images even when the surrounding vicinity of the vehicle 20 is dark, or may be a camera that operates in conjunction with lighting (not shown). In the second embodiment, the external camera 76 captures a still image, however, a moving image may also be captured.

The unit computation unit 78 includes a processor. By the processor thereof executing programs, the unit computation unit 78 functions as an image capturing control unit 84 and an information transmission unit 86. The image capturing control unit 84 controls an image capturing operation of the external camera 76, and causes the unit storage unit 80 to temporarily store the image information acquired by the external camera 76. The information transmission unit 86 transmits various types of information to the exterior via the unit communication unit 82.

The unit storage unit 80 includes a RAM and a ROM or the like. The unit storage unit 80 stores various programs.

The unit communication unit 82 includes a first communication unit 88 for exchanging information with the vehicle 20, and a second communication unit 90 for exchanging information with respective devices via the information communication network 22. The first communication unit 88 utilizes a technique of short range wireless communications, such as infrared communications or Bluetooth (registered trademark) or the like. Each of the communication devices includes a communication circuit, an antenna, and the like.

### 2.2. Pre-Delivery Process

Similar to the first embodiment, the pre-delivery process shown in FIG. 4 is also performed in the second embodiment.

### 2.3. Receiving Process Performed by Vehicle 20

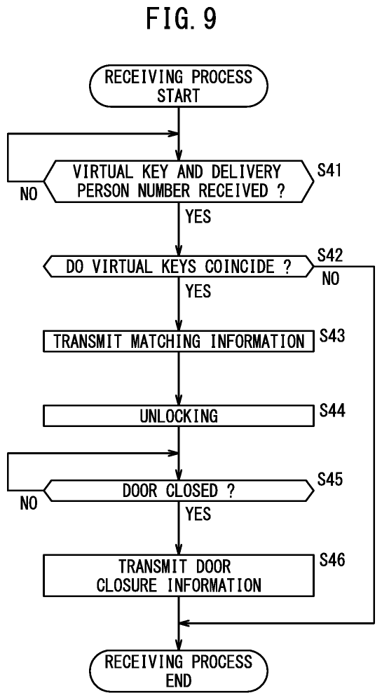

The receiving process shown in FIG. 9 is executed by the vehicle 20 while the vehicle 20 is parked. The receiving process is started in response to a trigger such as an operation of a process start switch (not shown), or an operation to turn off a power switch (not shown) of the vehicle 20, or the like.

The processes of steps S41, S42, S44, and S45 shown in FIG. 9 are the same as the processes of steps S21, S22, S24, and S25 shown in FIG. 5. Hereinafter, descriptions will be given of step S43 and step S46.

In step S42, in the case that the virtual key received by the unlocking unit 64 coincides with the virtual key stored in the vehicle storage unit 54 (step S42: YES), the process proceeds to step S43. In step S43, the information transmission unit 68 transmits information (matching information), which indicates that the virtual keys coincide with each other, to the camera unit 74. Moreover, the information transmission unit 68 transmits the delivery person number to the camera unit 74 together with the matching information. After the process of step S43 has been executed, the process proceeds to step S44.

In step S45, in the case of the door being closed (step S45: YES), the process proceeds to step S46. In step S46, the information transmission unit 68 transmits information indicating that the door has been closed (door closure information) to the camera unit 74. Upon completion of the foregoing steps, the receiving process is brought to an end.

### 2.4. Image Capturing Process Performed by Camera Unit 74

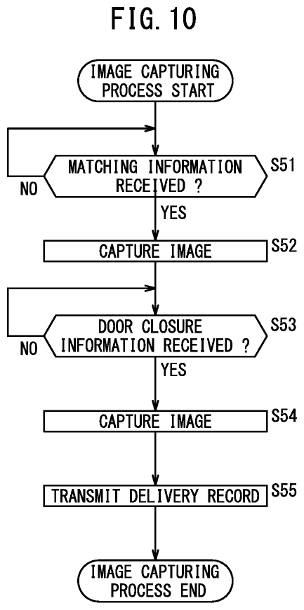

The image capturing process shown in FIG. 10 may be performed at all times, or may be initiated in the case that the camera unit 74 has received a starting instruction from the vehicle 20 or the delivery server 18.

In step S51, the image capturing control unit 84 determines whether or not the matching information has been received. In the case that the image capturing control unit 84 has received the matching information (step S51: YES), the process proceeds to step S52. On the other hand, in the case that the image capturing control unit 84 has not received the matching information (step S51: NO), the process of step S51 is performed repeatedly.

In step S52, the image capturing control unit 84 of the vehicle 20 outputs an image capturing signal to the external camera 76. The external camera 76 captures an image of the vehicle 20 in accordance with the image capturing signal. The image capturing control unit 84 causes the unit storage unit 80 to temporarily store the image information acquired by the external camera 76. In this instance, the stored image information (pre-delivery information) indicates the appearance of the surface of the vehicle 20 before the door is opened. After the process of step S52 has been executed, the process proceeds to step S53.

In step S53, the image capturing control unit 84 determines whether or not the door closure information has been received. In the case that the image capturing control unit 84 has received the door closure information (step S53: YES), the process proceeds to step S54. On the other hand, in the case that the image capturing control unit 84 has not received the door closure information (step S53: NO), the process of step S53 is performed repeatedly.

In step S54, the image capturing control unit 84 outputs an image capturing signal again to the external camera 76. The external camera 76 captures an image of the vehicle 20 in accordance with the image capturing signal. The image capturing control unit 84 causes the unit storage unit 80 to temporarily store the image information acquired by the external camera 76. In this instance, the stored image information (post-delivery information) indicates the appearance of the surface of the vehicle 20 after the door has been closed. After the process of step S54 has been executed, the process proceeds to step S55.

In step S55, the information transmission unit 86 associates the pre-delivery information, the post-delivery information, and the delivery person number, and thereby generates the delivery record 38. The information transmission unit 86 transmits the delivery record 38 to the delivery server 18. The delivery server 18 stores the delivery record 38 transmitted from the camera unit 74 in the server storage unit 26. Upon completion of the foregoing steps, the image capturing process is brought to an end.

### 2.5. Evaluation Process Performed by Delivery Server 18

In the same manner as the first embodiment, the evaluation process shown in FIG. 6 is performed in the second embodiment. However, in the case of the second embodiment, “foreign substances” in step S31 is replaced with “scratches or uncleanliness”.

### 3. Other Embodiments

### 3.1. First Example

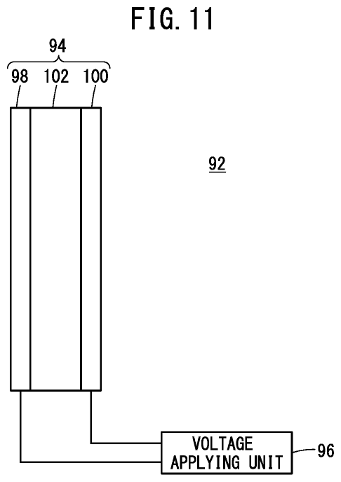

As an exemplary application in which the accommodation space is a cabin in the first embodiment, a lighting control unit 92 (see FIG. 11) may be provided in the vehicle 20. The lighting control unit 92 is equipped with a window glass 94 and a voltage applying unit 96.

The window glass 94 has a pair of glass panels 98 and 100 with electrodes provided on a window of the vehicle 20, and a transmittance modifying unit 102 sandwiched between the glass panels 98 and 100. For example, as the transmittance modifying unit 102, liquid crystal, SPD (Suspended Particle Device), or EC (Electrochromic) glass may be used. The voltage applying unit 96 applies a voltage to the electrodes of the glass panels 98 and 100 at a time when the internal camera 48 captures an image of the cabin.

When the voltage applying unit 96 applies such a voltage, the window glass 94 becomes opaque. Upon doing so, the internal camera 48 is made incapable of capturing an image of the exterior of the vehicle 20 through the window glass 94. As a result, the internal camera 48 captures an image of insects inside the cabin, whereas the internal camera 48 does not capture an image of insects outside of the vehicle 20.

### 3.2. Second Example

The delivery person evaluation system 10 according to the first and second embodiments evaluates the delivery person from the standpoint of objects (foreign substances, scratches, uncleanliness, etc.) that have a possibility of being made to increase in the vehicle 20. Instead of this feature, the delivery person evaluation system 10 may evaluate the delivery person from the standpoint of “strongly closing or fastening the door of the vehicle 20”, “searching the interior of the vehicle 20”, or “stopping of a hand truck in close proximity to the vehicle 20”. For example, a microphone provided internally or externally of the vehicle 20 picks up sounds at the time of delivery, and the delivery server 18 compares the picked up sounds with a threshold value, thereby determining whether or not an event of “strongly closing or fastening the door of the vehicle 20” has occurred. The events of “searching the interior of the vehicle 20”, or “stopping of a hand truck in close proximity to the vehicle 20” are capable of being captured by the internal camera 48 or the external camera 76.

### 3.3. Third Example

In the second embodiment, in the case that the external camera 76 captures a moving image, the delivery server 18 may appropriately modify a start time of image capturing or an end time of image capturing by the external camera 76.

### 4. Technical Concepts Obtained from the Embodiments

Technical concepts that can be grasped from the above-described embodiments will be described below.

An aspect of the present invention is characterized by the delivery person evaluation system 10 that evaluates the delivery person who delivers the parcel to the vehicle 20, the delivery person evaluation system 10 comprising the object detection unit 30 that detects the amount of objects that have a possibility of being made to increase in the vehicle 20 when the delivery person accommodates the parcel in the vehicle 20, and the evaluation unit 32 that evaluates the delivery person on the basis of the pre-delivery information, which is indicative of the amount of objects detected by the object detection unit 30 before the parcel is accommodated in the vehicle 20, and the post-delivery information, which is indicative of the amount of objects detected by the object detection unit 30 after the parcel has been accommodated in the vehicle 20.

In accordance with the above-described configuration, it is possible to grasp the amount of objects (insects, litter, scratches, uncleanliness, etc.) which may be made to increase in the vehicle 20 at the time that the delivery person delivers the parcel. The amount of objects (for example, an increase in the amount) can be used as a criterion for evaluating the delivery person. Therefore, according to the above-described configuration, the delivery person can be evaluated.

In the aspect of the present invention, there may further be provided the internal camera 48 that captures an image of the accommodation space of the vehicle 20 in which the parcel is accommodated, wherein the object may be foreign substances (insects or litter, etc.) that exist in the accommodation space, and the object detection unit 30 may detect the number of the foreign substances on the basis of the image information acquired by the internal camera 48.

In accordance with the above-described configuration, it is possible for the delivery person to be evaluated on the basis of the amount of foreign substances (insects or litter, etc.) that has entered into the accommodation space at the time of delivery.

In the aspect of the present invention, there may further be provided the unlock detection unit (unlocking unit 64) that detects that the door provided at the entry and exit opening of the accommodation space is unlocked, wherein the internal camera 48 may start to capture an image in the case it is detected by the unlock detection unit that the door is unlocked.

In the aspect of the present invention, there may further be provided the external camera 76 that captures an image of the surface of the vehicle 20, wherein the object may be scratching or uncleanliness that exists on the surface of the vehicle 20, and the object detection unit 30 may detect the number of the scratches or uncleanliness on the basis of the image information acquired by the external camera 76.

In accordance with the above-described configuration, it is possible for the delivery person to be evaluated on the basis of the amount of scratches or uncleanliness on the surface of the vehicle 20 at the time of delivery.

In the aspect of the present invention, there may further be provided the unlock detection unit (unlocking unit 64) that detects that the door provided at the entry and exit opening of the accommodation space of the vehicle 20 in which the parcel is accommodated is unlocked, wherein the external camera 76 may start to capture an image in the case it is detected by the unlock detection unit that the door is unlocked.

The delivery person evaluation system according to the present invention is not limited to the embodiments described above, and it is a matter of course that various modified or additional configurations could be adopted therein without deviating from the essence and gist of the

What is claimed is:

1. A delivery person evaluation system configured to evaluate a delivery person who delivers a parcel to a vehicle, the delivery person evaluation system comprising:
an object detection unit configured to detect an amount of objects that have a possibility of being made to increase in the vehicle when the delivery person accommodates the parcel in the vehicle; and
an evaluation unit configured to evaluate the delivery person on a basis of pre-delivery information indicative of the amount of objects detected by the object detection unit before the parcel is accommodated in the vehicle, and post-delivery information indicative of the amount of objects detected by the object detection unit after the parcel has been accommodated in the vehicle.

2. The delivery person evaluation system according to claim 1, further comprising an internal camera configured to capture an image of an accommodation space of the vehicle in which the parcel is accommodated, wherein the object is foreign substances that exist in the accommodation space, and the object detection unit detects a number of the foreign substances on a basis of image information acquired by the internal camera.

3. The delivery person evaluation system according to claim 2, further comprising an unlock detection unit configured to detect that a door provided at an entry and exit opening of the accommodation space is unlocked, wherein the internal camera starts to capture an image in the case it is detected by the unlock detection unit that the door is unlocked.

4. The delivery person evaluation system according to claim 1, further comprising an external camera configured to capture an image of a surface of the vehicle, wherein the object is scratches or uncleanliness that exists on the surface of the vehicle, and the object detection unit detects a number of the scratches or uncleanliness on a basis of image information acquired by the external camera.

5. The delivery person evaluation system according to claim 4, further comprising an unlock detection unit configured to detect that a door provided at an entry and exit opening of the accommodation space of the vehicle in which the parcel is accommodated is unlocked, wherein the external camera starts to capture an image in the case it is detected by the unlock detection unit that the door is unlocked.
